(19) United States
(12) Patent Application Publication
(10) Pub. No.: US 2025/0013226 A1
(43) Pub. Date: Jan. 9, 2025

(54) METHOD FOR PRODUCING AN ELECTRICAL SWITCHING OR CONTROL SYSTEM

(71) Applicant: RITTAL GMBH & CO. KG, Herborn (DE)

(72) Inventors: Ahmad ABRASS, Waldbrunn (DE); Thomas STEFFEN, Köln (DE)

(21) Appl. No.: 18/708,691

(22) PCT Filed: Oct. 13, 2022
(86) PCT No.: PCT/DE2022/100759

§ 371 Date: May 9, 2024

(30) Foreign Application Priority Data
Nov. 22, 2021 (DE) 10 2021 130 517.9

(51) Int. Cl. G05B 19/418; G06Q 50/04

(52) U.S. Cl. CPC G05B 19/41865; G06Q 50/04

(57) ABSTRACT

A method for manufacturing an electrical switchgear, comprising:
a. providing planning data relating to an electrical switchgear to be manufactured, said planning data comprising at least geometric data of the electrical switchgear to be manufactured;
b. determining required processing steps for manufacturing the electrical switchgear according to the planning data;
c. assigning the processing steps to at least one processing machine of a plurality of processing machines according to at least one selection criterion; and
d. performing the processing step with the at least one processing machine to which the processing step has been assigned.

### CROSS-REFERENCE TO RELATED APPLICATIONS

This application is a U.S. National Phase application under 35 U.S.C. 371 of International Application No. PCT/DE2022/100759, filed on Oct. 13, 2022, which claims the benefit of German Patent Application No. 10 2021 130 517.9, filed on Nov. 22, 2021. The entire disclosures of the above applications are incorporated herein by reference.

### BACKGROUND

This section provides background information related to the present disclosure which is not necessarily prior art.

### TECHNICAL FIELD

The invention relates to a method for producing an electrical switching or control system.

### DISCUSSION

A computer-implemented method for monitoring several cable processing machines and a corresponding monitoring system are known from EP 3 705 961 A1. Several cable processing stations are connected to a common control server and, for the purpose of monitoring, production parameters are sent from the cable processing machines to the control server, wherein the production parameters further comprise settings of the cable processing machines for processing the cables by the respective cable processing machine. The control server is accordingly configured to receive production parameters and to store them in a central database.

The methods known from the state of the art have the disadvantage that the input parameters for controlling the processing machines for producing electrical switching and control systems, which can comprise, for example, wiring machines, cable assembly machines, systems for machining flat parts and assembly machines, are production parameters, therefore machine data, which must be directly suitable for controlling a processing machine. However, these must first be generated starting from the planning. Thus, the process link between the mostly software-supported planning of the electrical switching or control system and the control of the processing machines for producing the planned switching or control system is missing.

### SUMMARY

This section provides a general summary of the disclosure and is not a comprehensive disclosure of its full scope or all of its features.

It is therefore one aspect of the invention to automate a method for producing an electrical switching or control system to such an extent that, after completion of the planning of the electrical switching or control system, as far as possible no human interaction is required until it is produced.

Accordingly, the method for producing an electrical switching or control system includes:
a. providing planning data relating to an electrical switchgear to be manufactured, said planning data comprising at least geometric data of the electrical switchgear to be manufactured;
b. determining required processing steps for manufacturing the electrical switchgear according to the planning data;
c. assigning the processing steps to at least one processing machine of a plurality of processing machines according to at least one selection criterion; and
d. performing the processing step with the at least one processing machine to which the processing step has been assigned.

Thus, the invention is based on the idea of deriving required processing steps for manufacturing the electrical switchgear starting from the planning data comprising geometric data of the electrical switchgear to be manufactured. For this purpose, planning data can be provided, for example, as AutomationML (Automation Markup Language) data, which can naturally comprise the required geometric data. These data can comprise data relating to the mechanical design, the electrical design and further geometric data, which can be used as a basis for determining the required processing steps.

The required processing steps derived from the geometric data can then be assigned to a suitable one of the plurality of processing machines depending on the processing step, for which the processing machines can be connected, for example, via a data interface to a data processing system, on which at least the above-mentioned steps a. to c. can be executed. In this respect, the method according to the invention can be executed as a computer-implemented method.

For example, for the control of a pick-and-place machine, with which, for example, electrical components are plugged onto a top-hat rail or mounted directly on a mounting plate, the providing can comprise providing planning data relating to a parts list of the electrical switchgear to be manufactured.

The determining can comprise matching an actual state of the electrical switchgear or control system or of a component of the electrical switchgear or control system with a target state of the electrical switchgear or control system, wherein the target state is predetermined by the planning data.

The assigning of the processing steps can comprise matching the processing capability of at least one of the processing machines with a processing requirement for performing the processing step.

The matching of the processing capability can comprise matching at least one technical-functional processing capability and preferably further at least one temporal processing capability with the processing requirement. The matching of the technical-functional processing capability can comprise, for example, checking the presence of a tool required for carrying out the processing step by the processing machine in question. For this purpose, the processing machine can transmit its technical-functional processing capabilities (“skills”), for example, to a data processing system which performs the assigning of the processing steps according to method step c. on the basis of its knowledge of the processing capabilities, wherein said processing capabilities can be, for example, a selection criterion.

The temporal processing capability relates, for example, to the utilization of the processing machine to which the processing step has been assigned or is to be assigned. In particular, if several, technically-functionally equivalent processing machines are present for the assigning of the processing step, to which the processing step could be assigned in the sense of a positive possible validation, the assigning can be carried out additionally on the basis of the selection criterion utilization.

The method can further comprise detecting at least one technical-functional processing capability per processing machine. In this case, the detected processing capability and its assignment to the associated processing machine can be stored in a memory, which memory is also accessed for the assigning of the processing steps. The memory can be, for example, a component of the data processing system already mentioned above for carrying out at least the steps a. to c.

After the assigning and before the performing of the processing step, the performing of an actual validation by the processing machine intended for performing the processing step can further be provided. In this case, at least one of availability of at least one component required for manufacturing the electrical switchgear and of a processing tool for performing the processing step can be checked.

In the case that the actual validation results in no availability or insufficient availability, it can be provided that another, technically-functionally equivalent processing machine is intended for performing the processing step. Alternatively, the geometric data of the switchgear to be manufactured can be replanned taking into account an actual availability of tools of the processing machine intended for performing the processing step and/or taking into account an actual availability of components required for manufacturing the electrical switchgear.

In the case that the actual validation results in a required processing tool being available but a tool change being required for using the tool, if possible, the processing step can be assigned to another processing machine with equivalent technical-functional processing capability.

The assigning of the processing steps according to at least one selection criterion for at least one and preferably for several of the plurality of processing machines can comprise: determining an availability of at least one component required for the processing step or at least one tool; and assigning the processing step to those of the processing machines which have the lowest utilization with a given availability.

The steps a. to c. can be performed by a data processing system, to which the plurality of processing machines are connected via a data interface. The processing machines can be configured to send a machine profile comprising at least one processing capability of the respective processing machine to the data processing system after the connection via the data interface.

The machine profile can be used as its selection criterion for the assigning of the processing steps to at least one of the plurality of processing machines, wherein the processing machine preferably sends an availability of at least one component required for the processing step or at least one tool required for the processing step to the data processing system periodically, continuously or upon request of the data processing system after the connection and the sending of the at least one processing capability, which is preferably used as a further selection criterion for the assigning of the processing steps.

If at least the steps a. to c. are performed with a data processing system, the processing machines can be configured to monitor the assigned processing step for completeness and/or correct execution and to send a corresponding processing protocol to the data processing system.

The determining of the required processing steps can comprise extracting processing data from the planning data, for which the planning data are preferably provided as AutomationML (Automation Markup Language) data.

Machine data for controlling the processing machine to which the processing step is assigned can be generated from the processing data, for which the processing machine communicates the machine data required for its operation to a data processing system via a data interface, so that the data processing system can generate and provide the machine data required for the operation in a suitable form.

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of selected embodiments and not all possible implementations and are not intended to limit the scope of the present disclosure.

Further details of the invention are explained with reference to the following FIG. 1.

FIG. 1 shows a schematic representation of an exemplary embodiment of a method according to the invention for manufacturing an electrical switchgear.

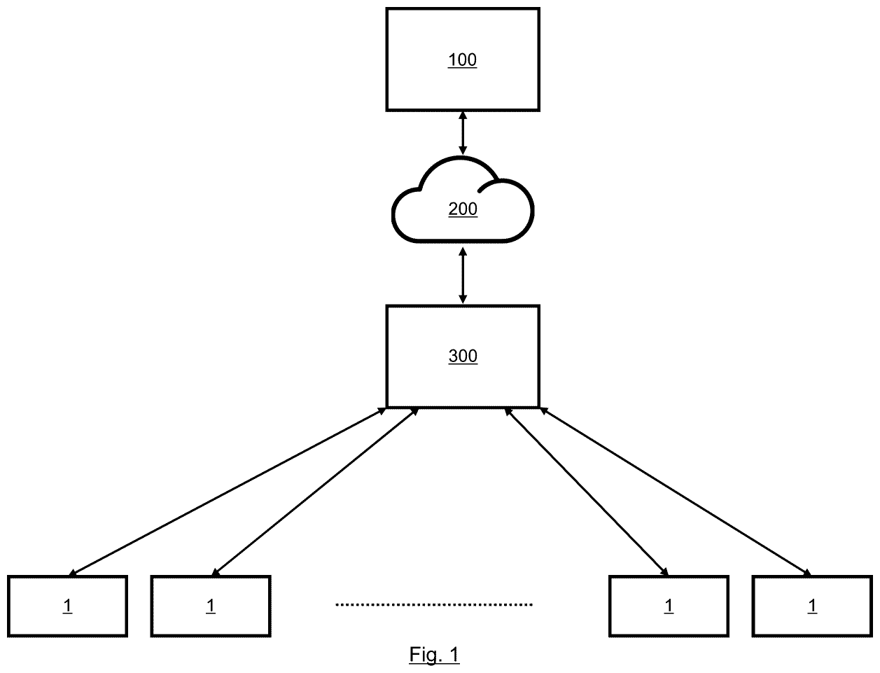

### DETAILED DESCRIPTION

Example embodiments will now be described more fully with reference to the accompanying drawing.

In principle, the method can be implemented completely in software except for the processing machines 1, therefore can be executed as a computer-implemented method. Planning software 100, for example the commercially available software Eplan Pro Panel for 2D and 3D planning in switchgear and control system construction, can be used to create a complete planning of an electrical switching or control system in a computer-protected manner in a partially automated manner. The engineering data generated in this case can be provided as AutomationML data (AML data) and stored, for example, in a cloud 200, for instance a decentralized server, for remote access. As a result, the planning data can be accessed centrally and a manufacturing order can be created locally independently of the manufacturing of the switchgear.

The AML data naturally also comprise in particular geometric data of the electrical switchgear to be manufactured. These can be geometric data relating to the electrical components of the electrical switchgear to be manufactured. The geometric data can also comprise information relating to the wiring, for example cable lengths, cable assemblies, routing routes and the like. The geometric data can comprise air-conditioning information, for example relating to a provided switchgear cabinet air-conditioning infrastructure, an air guide, including mounting data. The geometric data can comprise a mechanical processing of a switchgear cabinet housing, a flat part, a mounting plate or the like, for example the introduction of borehole patterns for the mounting of top-hat rails and components, or of breakouts for the mounting of filter fans and the like.

These geometric data preferably provided as ALM data can be used to determine the required processing steps for manufacturing the electrical switching or control system with the aid of a data processing system 300. The data processing system 300 has access to the cloud 200. The determining can comprise in particular the extracting of processing data from the geometric data or AML data. The data processing system 300 is not restricted to any particular embodiments and can be cloud-based (software as a service) or implemented on a local server.

As a result of the fact that the computer-implemented method or the data processing system can be executed substantially cloud-based, the extracted data can be accessed locally independently and a manufacturing order can be created for this purpose. The data can be analyzed decentralized and suitable processing processes can be determined therefrom. These relate, in accordance with the geometric data mentioned above, to processing data, for example for the cutting or laser-assisted introduction of breakouts, borehole patterns and the like, pick-and-place data, for instance in relation to the, for example, robot-assisted positioning and mounting of switchgear cabinet components, and also wiring information for the preferably fully automated wiring of the components, including cable routing routes, cable end feed routes in relation to components, and also quality assurance measures, for example the determination of a pull-off strength of a manufactured electrical wiring.

If the required processing steps for manufacturing the electrical switchgear have been determined from the geometric data, these processing steps can be assigned to at least one of several processing machines which are connected to the data processing system via a data interface. The assigning can be carried out using at least one selection criterion. The selection criterion can be, for example, a utilization of the processing machine in question and preferably comprise a possible validation and an actual validation. In the case of the possible validation, it is determined whether the processing machine in question is fundamentally, i.e. technically-functionally, capable of carrying out the required processing steps. For example, a breakout can be generated with a cutting processing machine or with a laser processing system. However, the breakout cannot be manufactured with a wiring robot which, in addition to the processing machines mentioned above and further a multiplicity of processing machines required in the switching and control system construction, is connected to the data processing system for central control in a network of processing machines.

The actual validation can comprise determining, at a processing machine which comprises, for example, an exchangeable tool, whether the processing machine in question has set up a suitable tool at the moment of assigning and/or carrying out the processing step, so that a conversion to another tool is not required and set-up times can be dispensed with. In particular in larger processing systems, in which several technically-functionally equivalent processing machines are optimized for the maximum utilization, the actual validation can lead to an assigning of the processing step to an alternative processing machine, for which not only the possible validation but also the actual validation is decided positively, being carried out in the case of a positively determined possible validation.

The method can further comprise a quality check to the effect that the processing machines detect the process sequences carried out by them, including movement sequences and other processing sequences, and transmit a corresponding protocol data record to the data processing system, in which the protocol data record for the quality check is stored and can be retrieved as required.

Finally, it can be provided that, in the already described network of a multiplicity of processing machines, which can be partially similar to one another but also technically-functionally different from one another, the new processing machine registers itself in the system, for example communicates to the data processing system, in the case of a new assignment of a processing machine, which technically-functional functional scope it comprises and, if appropriate, with which type of machine data it can be controlled, so that the central data processing system can use the functional scope of the machines as a selection criterion for assigning the processing steps and can provide the conditioning of the machine data in a suitable manner.

In order to achieve a uniform utilization of processing machines with the same or similar technically-functional functional scope, it can be provided that the processing steps and the processing orders derived therefrom are split, so that several partial orders can be distributed to different processing machines. The splitting of the order can in turn depend on different selection criteria, for example on the set-up tool of the different processing machines, wherein an optimization can be achieved to the effect that, if possible, a conversion of the respective tool of the two processing machines is not required in order to carry out the order.

After the processing machine has been assigned the processing step, it performs an actual validation. In addition to the aspects already mentioned above, the actual validation can also comprise a check for material availability, for example if the processing machine is a component placement system or a wiring robot. In the case of a negative actual validation, the processing step or the order derived therefrom can be sent back to the data processing system. There, the order or the processing step can either be modified manually in order to achieve an automated processing of the processing step by at least one of the processing machines. Alternatively, the processing step can also be provided for the reassignment to an alternative processing machine.

The status of all processing steps or at least a subset thereof can be monitored continuously or periodically to the effect whether the processing order has been successfully assigned to a processing machine and whether the order has been properly executed by the processing machine, including an error protocol possibly generated by the processing machine. The protocol can document the movement sequences and processing sequences of the processing machine. In the case of a cutting/drilling processing machine, these can be, for example, introduced borehole patterns and breakouts which are compared with corresponding borehole patterns and breakouts in the geometric data and a sufficient or exact correspondence is possibly acknowledged. In the case of a wiring robot, this can comprise the proper wiring according to a wiring plan of the planning data, including compliance with a predetermined routing route, a contacting, a pull-off test, a resistance test, etc.

The features of the invention disclosed in the above description, in the drawing and in the claims can be essential both individually and in any combination for the realization of the invention.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-15. (canceled)

16. A method for manufacturing an electrical switchgear, comprising:
a. providing planning data relating to an electrical switchgear to be manufactured, said planning data comprising at least geometric data of the electrical switchgear to be manufactured;
b. determining required processing steps for manufacturing the electrical switchgear according to the planning data;
c. assigning the processing steps to at least one processing machine of a plurality of processing machines according to at least one selection criterion; and
d. performing the processing step with the at least one processing machine to which the processing step has been assigned,
wherein the determining comprises matching an actual state of the electrical switchgear or of a component of the electrical switchgear with a target state of the electrical switchgear, wherein the target state is predetermined by the planning data.

17. The method according to claim 16, wherein the providing planning data comprises providing planning data relating to a parts list of the electrical switchgear to be manufactured.

18. The method according to claim 16, wherein the assigning of the processing steps comprises matching the processing capability of at least one of the processing machines with a processing requirement for carrying out the processing step.

19. The method according to claim 18, wherein the matching of the processing capability comprises matching at least one technical-functional processing capability and preferably further at least one temporal processing capability with the processing requirement.

20. The method according to claim 16, which further comprises detecting at least one technical-functional processing capability per processing machine, wherein the detected processing capabilities are stored in a memory with assignment of the associated processing machine, which memory is accessed for the assigning of the processing steps.

21. The method according to claim 16, which further comprises, after the assigning and before the performing of the processing step, performing an actual validation by the processing machine intended for performing the processing step, wherein at least one of availability of at least one component required for manufacturing the electrical switchgear and of a processing tool for performing the processing step is checked.

22. The method according to claim 21, wherein, in the case that the actual validation results in no availability or insufficient availability, another processing machine is intended for performing the processing step or the geometric data of the electrical switchgear to be manufactured is replanned taking into account an actual availability of tools of the processing machine intended for performing the processing step and/or taking into account an actual availability of the components required for manufacturing the electrical switchgear.

23. The method according to claim 21, wherein, in the case that the actual validation results in a required tool being available but a tool change being required for using the tool, if possible, the processing step is assigned to another processing machine with equivalent technical-functional processing capability.

24. The method according to claim 16, wherein the assigning of the processing steps according to at least one selection criterion for at least one and preferably for several of the plurality of processing machines comprises: determining an availability of at least one component required for the processing step or at least one tool and assigning the processing step to those of the processing machines which have the lowest utilization with a given availability.

25. The method according to claim 16, wherein at least the steps a. to c. are performed with a data processing system, to which the plurality of processing machines are connected via a data interface, wherein the processing machines are configured to send a machine profile comprising at least one processing capability of the respective processing machine to the data processing system after the connection via the data interface.

26. The method according to claim 25, wherein the machine profile is used as a selection criterion for the assigning of the processing steps to at least one of the plurality of processing machines, wherein the processing machine preferably sends an availability of at least one component required for the processing step or at least one tool required for the processing step to the data processing system periodically, continuously or upon request of the data processing system after the connection and the sending of the at least one processing capability, which is preferably used as a further selection criterion for the assigning of the processing steps.

27. The method according to claim 16, wherein at least the steps a. to c. are performed with a data processing system, to which the plurality of processing machines are connected via a data interface, wherein the processing machines are configured to monitor the assigned processing step for complete and correct execution and to send a corresponding processing protocol to the data processing system.

28. The method according to claim 16, wherein the determining of required processing steps comprises extracting processing data from the planning data, for which the planning data are preferably provided as AutomationML (Automation Markup Language) data.

29. The method according to claim 28, wherein machine data for controlling the processing machine to which the processing step is assigned are generated from the processing data, for which the processing machine communicates the machine data required for its operation to a data processing system via a data interface.
